(19) United States
(12) Patent Application Publication
(10) Pub. No.: US 2020/0151971 A1
(43) Pub. Date: May 14, 2020

(54) LEDGER MANAGEMENT DEVICE, LEDGER MANAGEMENT SYSTEM, AND VEHICLE-MOUNTED INFORMATION PROVISION DEVICE

(71) Applicant: DENSO CORPORATION, Kariya-city (JP)

(72) Inventors: Tomoya OGAWA, Kariya-city (JP); Hiroyuki KISHITA, Kariya-city (JP); Takashi UEFUJI, Kariya-city (JP); Tsuneo NAKATA, Kariya-city (JP)

(21) Appl. No.: 16/740,063

(22) Filed: Jan. 10, 2020

Related U.S. Application Data
(63) Continuation of application No. PCT/JP2018/026512, filed on Jul. 13, 2018.

(30) Foreign Application Priority Data
Jul. 24, 2017 (JP) 2017-143013

(51) Int. Cl. G07C 5/08; G06F 16/23; G07C 5/00; G06F 16/182; H04L 9/06

(52) U.S. Cl. CPC G07C 5/0808; G06F 16/2322; G07C 5/085; H04L 2209/38; G06F 16/1834; H04L 9/0643; G07C 5/008

(57) ABSTRACT

A ledger management system includes multiple ledger management devices communicably connected to each other. The ledger management devices have a same distributed ledger. Each ledger management device includes the distributed ledger, an agreement determination unit, and a ledger storage unit. The distributed ledger stores ledger information, including specific information specific to a previous ledger information and present vehicle information obtained from a vehicle, that is generated by one of the ledger management devices. The agreement determination unit determines whether the ledger information generated by the one of the ledger management devices satisfies an agreement rule. The ledger storage unit stores the ledger information in the distributed ledger when the ledger information satisfies the agreement rule, and does not store the ledger information in the distributed ledger when the ledger information does not satisfy the agreement rule.

### CROSS REFERENCE TO RELATED APPLICATION

The present application is a continuation application of International Patent Application No. PCT/JP2018/026512 filed on Jul. 13, 2018, which designated the U.S. and claims the benefit of priority from Japanese Patent Application No. 2017-143013 filed on Jul. 24, 2017. The entire disclosures of all of the above applications are incorporated herein by reference.

### TECHNICAL FIELD

The present disclosure relates to relates to a technology for managing vehicle information acquired by a vehicle using a distributed ledger.

### BACKGROUND

There is known a technology for transmitting vehicle information acquired by a vehicle based on a predetermined acquisition condition from the vehicle to a center. A technique is provided such that an external terminal connected to the center inputs the acquisition condition of the vehicle information acquired by the vehicle into the center. The technique provides such that the vehicle information which the vehicle acquires based on the acquisition condition is transmitted from the vehicle to the center, and the vehicle information is transmitted from the center to an external terminal in which the corresponding acquisition condition is input.

### SUMMARY

A ledger management system includes multiple ledger management devices communicably connected to each other. The ledger management devices have a same distributed ledger. Each ledger management device includes the distributed ledger, an agreement determination unit, and a ledger storage unit. The distributed ledger stores ledger information, including specific information specific to a previous ledger information and present vehicle information obtained from a vehicle, that is generated by one of the ledger management devices. The agreement determination unit determines whether the ledger information generated by the one of the ledger management devices satisfies an agreement rule. The ledger storage unit stores the ledger information in the distributed ledger when the ledger information satisfies the agreement rule, and does not store the ledger information in the distributed ledger when the ledger information does not satisfy the agreement rule.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a ledger management system according to a first embodiment;

FIG. 2 is a block diagram showing the configuration of a ledger management device;

FIG. 3 is a schematic view showing the configuration of a distributed ledger;

FIG. 4 is a block diagram showing a vehicle-mounted information provision device;

FIG. 5 is a sequence diagram showing an initial registration process of a vehicle;

FIG. 6 is a sequence diagram showing a registration process of vehicle information;

FIG. 7 is a block diagram showing a ledger management system according to a second embodiment.

FIG. 8 is a block diagram showing a ledger management device mounted on a vehicle; and

FIG. 9 is a schematic view showing a traveling state of a vehicle constituting the ledger management device.

### DETAILED DESCRIPTION

Another terminal in addition to an external terminal in which the acquisition condition is input may refer to the vehicle information acquired by the vehicle and transmitted to the center. In this case, it is conceivable that the center records and manages vehicle information, transmitted from the vehicle to the center, in a database, and a plurality of terminals refer to the database in the center. However, when the vehicle information is managed only by the center, it is found by the detailed study of the inventors that it is difficult to prevent the vehicle information managed by the center from being illegally rewritten by a third party. Also, it is also found that it is difficult for other terminals to detect or prevent falsification due to internal fraud at the center.

A technique is provided such that a plurality of ledger management devices manage the vehicle information acquired from a vehicle using a distributed ledger.

According to an example embodiment, a ledger management device, in a ledger management system including a plurality of ledger management devices communicably connected to each other, and the plurality of ledger management devices having a same distributed ledger, comprises: the distributed ledger; an agreement determination unit; and a ledger storage unit.

The distributed ledger stores ledger information including specific information specific to an immediately previous ledger information generated by one of the plurality of ledger management devices and current vehicle information acquired from the vehicle.

The agreement determination unit determines whether the ledger information generated by the one of the plurality of ledger management devices satisfies an agreement rule set in the plurality of ledger management devices. When the agreement determination unit determines that the ledger information satisfies the agreement rule, the ledger storage unit stores the ledger information in the distributed ledger. When the agreement determination unit determines that the ledger information does not satisfy the agreement rule, the ledger storage unit does not store the ledger information in the distributed ledger.

According to an example embodiment, a ledger management system comprises a plurality of ledger management devices communicably connected to each other. The plurality of ledger management devices has a same distributed ledger. Each of the plurality of ledger management devices includes the distributed ledger, an agreement determination unit, and a ledger storage unit.

The distributed ledger stores ledger information including specific information specific to an immediately previous ledger information generated by one of the plurality of ledger management devices and current vehicle information acquired from the vehicle.

The agreement determination unit determines whether the ledger information generated by the one of the plurality of ledger management devices satisfies an agreement rule set in the plurality of ledger management devices. When the agreement determination unit determines that the ledger information satisfies the agreement rule, the ledger storage unit stores the ledger information in the distributed ledger. When the agreement determination unit determines that the ledger information does not satisfy the agreement rule, the ledger storage unit does not store the ledger information in the distributed ledger.

According to the ledger management device and the ledger management system described above, the ledger information constituting the distributed ledger includes the specific information specific to the immediately previous ledger information and the current vehicle information acquired from the vehicle. Therefore, when the ledger information in one of the distributed ledgers is rewritten, the specific information stored in next ledger information is different from the specific information generated from rewritten ledger information.

Therefore, when the specific information generated from the rewritten ledger information is compared with the specific information stored in the next ledger information, it is possible to detect that the ledger information has been rewritten.

Further, since the ledger information that does not satisfy the agreement rule set in the plurality of ledger management devices is not stored in the distributed ledger, it is possible to prevent from recording fraud ledger information not satisfying the agreement rule in the distributed ledger.

According to an example embodiment, a vehicle-mounted information provision device provides vehicle information to a ledger management system.

The ledger management system includes a plurality of ledger management devices communicably connected to each other. The plurality of ledger management devices has a same distributed ledger. The vehicle-mounted information provision device comprises an information management unit and a communication unit.

The distributed ledger includes specific information specific to an immediately previous ledger information generated by one of the plurality of ledger management devices and current vehicle information provided by the vehicle-mounted information provision device. The distributed ledger stores ledger information that satisfies an agreement rule set in the plurality of the ledger management devices.

The information management unit acquires proper vehicle information from the in-vehicle electronic control unit. The communication unit transmits the proper vehicle information acquired by the information management unit to the ledger management system.

According to this configuration, since the proper vehicle information is transmitted from the in-vehicle electronic control unit to the ledger management system, the proper vehicle information is stored in the distributed ledger.

Embodiments of the present disclosure will be described below with reference to the drawings.

### 1. First Embodiment

[1-1. Configuration]

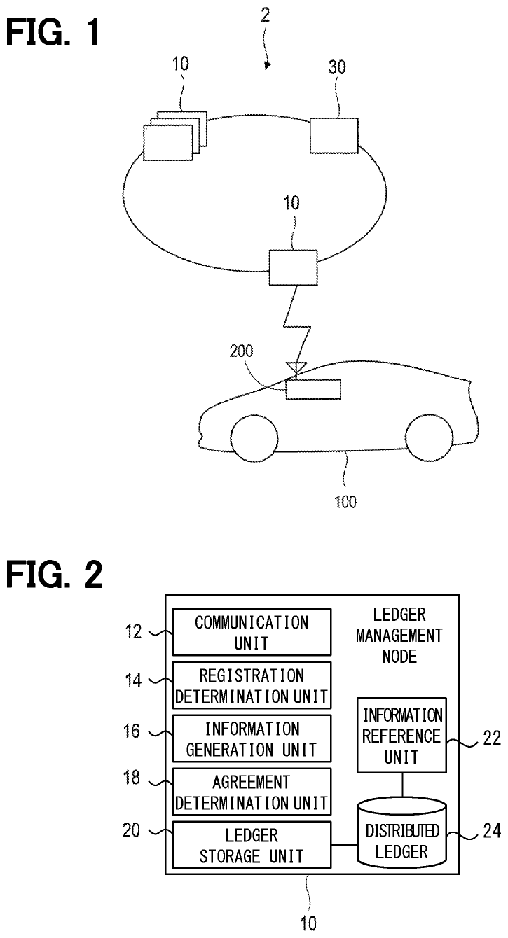

The ledger management system 2 shown in FIG. 1 includes a plurality of ledger management devices 10 and an electronic certification authority 30. The ledger management system 2 stores and manages vehicle information, provided by communication from the vehicle 100, in the distributed ledger. The plurality of ledger management devices 10 and the electronic certification authority 30 constitute a peer-to-peer network system communicably connected to each other.

Each ledger management device 10 stores the device list, in which the proper ledger management device in the ledger management system 2 is registered, in the rewritable non-volatile storage device. In the device list, the IP address of each ledger management device 10 and the electronic certificate are registered. In the electronic certificate, the public key of each ledger management device 10 and the electronic signature are registered. Registration in the device list is executed offline by a trusted registrant in response to a registration request, or executed online in a procedure similar to the initial registration of a vehicle described later.

When the ledger management device 10 does not execute the communication in the ledger management system 2 for a predetermined time or more due to a communication failure, breakdown of the ledger management device 10, or the like, the corresponding ledger management device 10 may be deleted from the device list. When the ledger management device 10 deleted from the device list recovers from a communication failure, breakdown of the ledger management device 10 or the like, the device 10 requests registration for the device list again.

The ledger management device 10 is, for example, a device disposed in a vehicle manufacturing company, a vehicle insurance company, a provider of in-vehicle software, used car sales, or the like.

The ledger management device 10 is mainly configured of a well-known computer having a CPU and a semiconductor memory such as a RAM, a ROM, and a flash memory. The various functions of the ledger management device 10 are realized by the CPU executing a program stored in the non-transitory tangible storage medium. The semiconductor memory may correspond to a non-transitory tangible storage medium for storing a program.

The CPU executes the program so that a method corresponding to the program is performed. The ledger management device 10 may be configured by one computer or may be configured by a plurality of computers.

As shown in FIG. 2, the ledger management device node 10 has, as the configuration of functions realized by executing a program by the CPU, the communication unit 12, the registration determination unit 14, the information generation unit 16, and the agreement determination unit 18, a ledger storage unit 20, an information reference unit 22, and a distributed ledger 24.

The method for realizing these functions constituting the ledger management device 10 is not limited to software, and some or all of the elements may be realized by one or more hardware. For example, when the above functions are implemented by an electronic circuit that is hardware, the electronic circuit may be implemented by a digital circuit that includes a large number of logic circuits, an analog circuit, or a combination of the digital circuit and the analog circuit.

The communication unit 12 communicates with the other ledger management device 10, the electronic certification authority 30, and the vehicle 100. The registration determination unit 14 determines whether it is an initial registration request from an proper vehicle 100, based on transmission source information such as a VIN number transmitted from the vehicle 100 and a telephone number of the owner of the vehicle when the vehicle 100 providing and transmitting the vehicle information to the ledger management system 2 requests the initial registration. The information generation unit 16 generates ledger information to be recorded in the distributed ledger 24 based on the vehicle information transmitted from the vehicle 100.

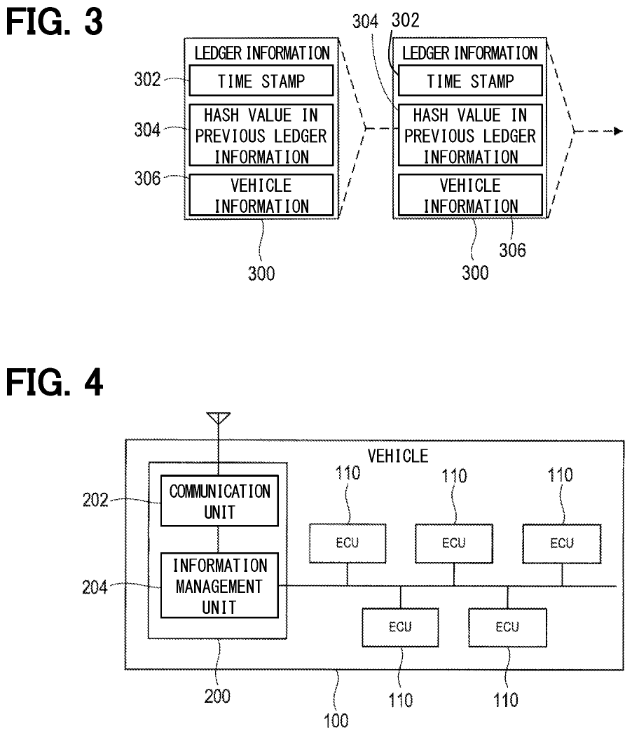

As shown in FIG. 3, the ledger information 300 stores a time stamp 302 when the ledger information is generated, a hash value 304 generated from the immediately previous ledger information 300, and current vehicle information 306. That is, the database constituted by the ledger information 300 shown in FIG. 3 provides a block chain.

The agreement determination unit 18 determines whether the ledger information generated by the other ledger management device 10 satisfies the agreement rule set in advance in the plurality of ledger management devices 10 constituting the ledger management system 2. POW, PBFT, etc. are known as the agreement rule. POW stands for Proof of Work, and PBFT stands for Practical Byzantine Fault Tolerance.

The ledger storage unit 20 stores the ledger information, determined by the agreement determination unit 18 as satisfying the agreement rule, in the distributed ledger 24.

The information reference unit 22 refers to the ledger information 300 that is requested to utilize from the distributed ledger 24. When referring to the ledger information 300, the information reference unit 22 compares the hash value generated from the ledger information 300 referred to the present time with the hash value 304 recorded in the next ledger information 300, and determines whether the vehicle information 306 of the ledger information 300 referred to the present time is proper.

When the proper applicant applies for registration of the public key, the electronic certificate authority 30 creates and publishes an electronic certificate of the public key. The electronic certificate authority 30 may be any one of the ledger management devices 10 that may double as the electronic certificate authority 30, or may be a dedicated electronic certificate authority 30. Alternatively, multiple electronic certification authorities 30 may exist.

As shown in FIG. 4, the vehicle 100 includes a plurality of electronic control units 110 and an information provision device 200. The electronic control unit is also defined an ECU. Each ECU 110 controls steering, braking, generating a travelling torque, in-vehicle audio, display and the like.

Each ECU 110 and the information provision device 200 communicate, for example, by a CAN or Ethernet protocol. CAN is an abbreviation of Controller Area Network, and CAN and Ethernet are registered trademarks.

In the communication between each ECU 110 and the information provision device 200, security measures such as encryption of a communication message using a key are taken. By performing the security measures as described above in the communication in the vehicle 100, even if an unauthorized ECU is connected to the network of the vehicle 100 and the vehicle information is transmitted, it is possible to detect that the vehicle information is unauthorized.

In addition, when the vehicle communicates with the external device such as a smartphone or an internet connection line, it is possible to suppress unauthorized communication from the external device to the vehicle 100 by providing the security function of the gateway in the information management unit 204 described later.

The information provision device 200 includes a communication unit 202 and an information management unit 204. The communication unit 202 communicates with the ledger management device 10 of the ledger management system 2.

The information management unit 204 acquires the vehicle information from the ECU 110, and the vehicle information includes a usage history indicating how the vehicle 100 has been used, a traveling history indicating how the vehicle 100 has traveled, and a configuration of software installed in each ECU 110. The information management unit 204 acquires proper vehicle information from the ECU 110 according to the security measures described above.

The information management unit 204 encrypts the vehicle information acquired from the ECU 110 with a secret key to generate an electronic signature, and transmits the electronic signature from the communication unit 202 to the ledger management system 2 together with the vehicle information.

[1-2. Process]

(1) Initial Registration Process

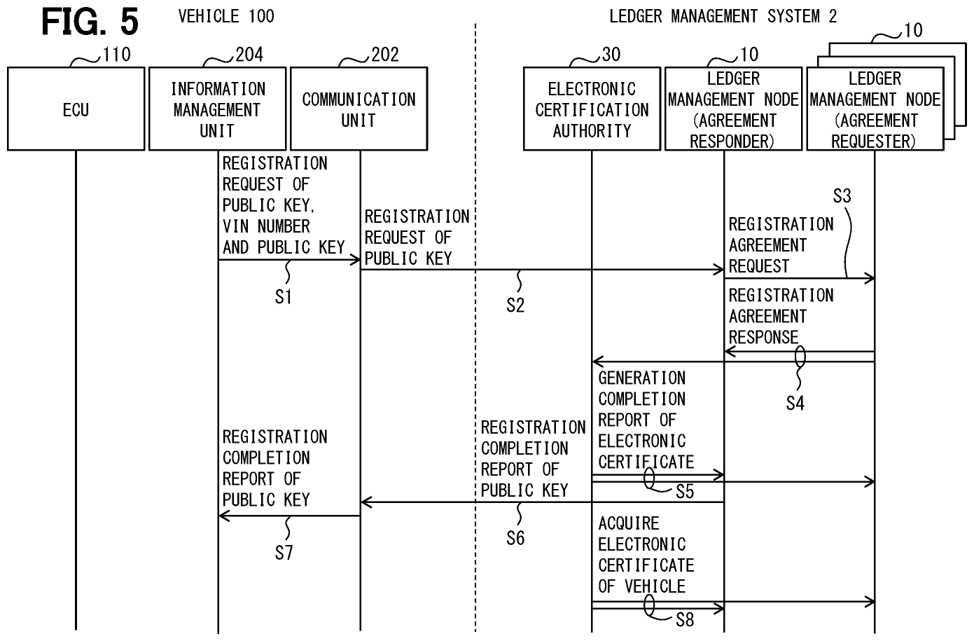

A process when the vehicle 100 performs initial registration for providing the vehicle information to the ledger management system 2 will be described based on the sequence diagram in FIG. 5. Here, before performing the initial registration, a public key and a secret key for communicating with the ledger management system 2 are set in the information management unit 204 of the vehicle 100 in advance.

In S1 and S2, the information management unit 204 transmits the initial registration request, the VIN number of the host vehicle, and the public key from the communication unit 202 to the specific ledger management device 10. The specific ledger management device 10 is disposed, for example, at the information center of the company that manufactured the vehicle 100.

It is desirable that the line used when the vehicle 100 transmits to the specific ledger management device 10 for the initial registration request may be a dedicated line or a line capable of maintaining security such as VPN. The VPN is an abbreviation of Virtual Private Network.

The ledger management device 10 that has received the initial registration request, the VIN number and the public key from the vehicle is defined as an agreement requester requesting the other ledger management device 10 to agree on the initial registration request. The ledger managing device 10, which is an agreement requester, determines whether the registration request is an initial registration request from the proper vehicle 100, based on transmission source information such as the VIN number transmitted from the vehicle 100 and the telephone number of the owner of the vehicle. In case of the initial registration request from the improper vehicle 100, the ledger managing device 10, which is an agreement requester, ignores the current initial registration request.

In case of the initial registration request from the proper vehicle 100, the ledger managing device 10, which is an agreement requester, generates a hash value from the immediately previous ledger information, and generates the current ledger information by adding the initial registration request, the VIN number and the public key as the vehicle information into the hash value and the time stamp.

In S3, the ledger management device 10, which is an agreement requester, transmits the generated ledger information to the other ledger management device 10, and requests to agree on the initial registration request of the corresponding vehicle. The other ledger management device 10 that receives the ledger information is defined as an agreement responder with respect to the agreement requester.

The ledger management device 10, as an agreement responder which has received the agreement request for the initial registration request, determines whether the ledger management device 10 as an agreement requester is a proper ledger management device 10. This determination is performed, for example, based on whether the ledger management device 10 as the agreement requester is registered in the device list.

When the ledger management device 10 as the agreement requester is the proper ledger management device 10, in S4, the ledger management device 10 as the agreement responder responds to agree on the agreement request to the electronic certification authority 30 and the ledger management device 10 as the agreement requester 10.

In S5, when the predetermined number or more of ledger management devices 10 agree on the agreement request, the electronic certificate authority 30 notifies to all ledger management devices 10 that the creation of the electronic certificate, in which the public key and the electronic signature of the vehicle 100 that requests the initial registration are registered, is completed. The electronic certificate authority 30 notifies the URL of the created electronic certificate in the notification of completion of creation of the electronic certificate. The URL is an abbreviation of Uniform Resource Locator.

The ledger management device 10, notified from the electronic certificate authority 30 that the creation of the electronic certificate is completed, adds and records the ledger information received from the ledger management device 10 as the agreement requester into the distributed ledger 24 in S3. As a result, the distributed ledger 24 provided in each of the plurality of ledger management devices 10 is synchronously updated, so that the distributed ledger 24 provided in each of the plurality of ledger management devices 10 has the same content.

In S6 and S7, the electronic certificate authority 30 reports, to the vehicle 100 that has requested the initial registration, that the registration of the public key is completed. The vehicle 100 that has been reported to register the public key determines that the initial registration for providing the vehicle information to the ledger management system 2 is completed.

In S8, the ledger management device 10 acquires the electronic certificate of the vehicle 100 registered for the first time from the URL notified from the electronic certificate authority 30.

(2) Vehicle Information Registration Process

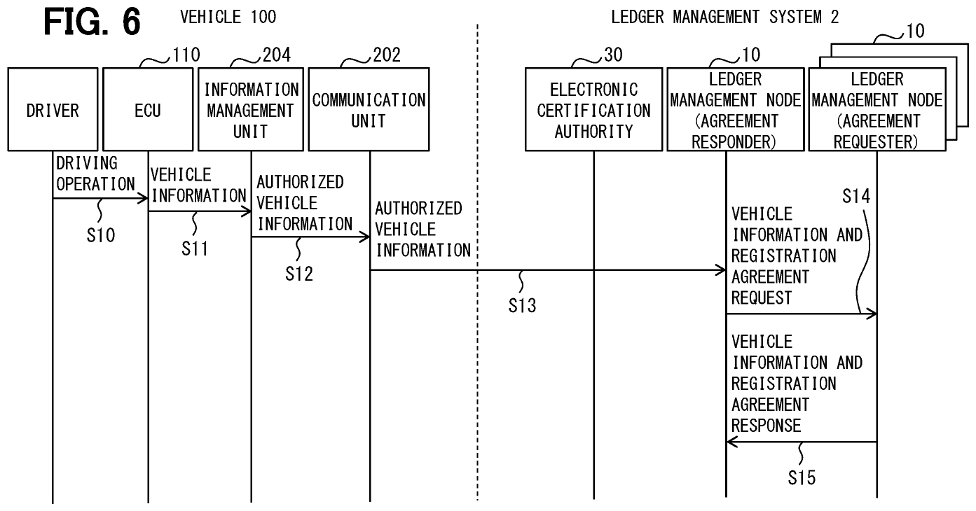

A vehicle information registration process in which the vehicle 100 provides vehicle information to the ledger management system 2 will be described with reference to the sequence diagram of FIG. 6.

For example, when the vehicle 100 starts traveling, the ECU 110 acquires the travelling records from the detection signal of the sensors in S10, the travelling records indicative of the amount of operation of the accelerator pedal, the brake pedal, the steering wheel and the like, the vehicle speed and the acceleration as the vehicle information provided from the vehicle to the ledger management system 2, that is how the vehicle 100 has traveled. In S11, the information management unit 204 acquires the vehicle information from the ECU 110.

The information management unit 204 may acquire the software configuration in the vehicle 100 and the usage history indicating how the vehicle 100 has been used, from the ECU 110 as vehicle information in addition to the travel records.

The software configuration in the vehicle 100 is, for example, information indicating that the software installed in the vehicle 100 has been updated or new software such as a travel function has been purchased or the like, in addition to the software installed in the vehicle 100.

The usage history is, for example, information indicating a record providing that the traveling mode of the vehicle 100 has been switched to the automatic operation mode or the manual operation mode, an oil replacement record, a maintenance inspection record of the vehicle, the number of owners, the traveling distance, and the like when the vehicle 100 is shared by multiple owners.

When communication with the ledger management system 2 is interrupted because the vehicle 100 transmitting the vehicle information to the ledger management system 2 travels in an underground parking lot, in a tunnel, in a mountain area, etc., the information management unit 204 temporarily stores the vehicle information while the communication is interrupted. When the communication with the ledger management system 2 is restored, the temporarily stored vehicle information is transmitted to the ledger management system 2. In S12 and S13, the information management unit 204 transmits, from the communication unit 202 to the specific ledger management device 10 which is defined as the agreement requester of the ledger management system 2, the acquired vehicle information, the electronic signature obtained by encrypting the hash value generated from the vehicle information with the secret key, the time, and the like. The line used in S12 and S13 may be a general-purpose line such as an Internet line in addition to a dedicated line or VPN as in case of the above-described initial registration request.

The ledger management device 10, which is an agreement requester receiving the vehicle information from the vehicle 100, determines that the registration request of the vehicle information is performed from the proper vehicle 100 when the hash value generated from the vehicle information by the hash function matches with the hash value decoded from the electronic signature using the public key of the corresponding vehicle 100.

When the registration request of the vehicle information is performed from the proper vehicle 100, the ledger management device 10, which is the agreement requester in S14, generates a hash value based on the previous ledger information, and thus, produces this hash value, time stamp, vehicle information received from the vehicle 100 as the ledger information. Then, the ledger management device 10, which is the agreement requester, transmits the generated ledger information to the other ledger management device 10, and requests the agreement for registering the vehicle information in the distributed ledger 24.

The ledger management device 10, as an agreement responder which has received the agreement request for the vehicle information registration, determines whether the ledger management device 10 as an agreement requester is a proper ledger management device 10. This determination is performed, for example, based on whether the ledger management device 10 which is the agreement requester is the proper ledger management device 10 registered in the device list.

When the ledger management device 10 which is the agreement requester is the proper ledger management device 10 registered in the device list, the ledger management device 10 as the agreement responder responds in S15 to agree the agreement request of the vehicle information registration with the ledger management device 10 as the agreement requester and the ledger management device 10 which is another agreement responder.

When the ledger management device 10 as the agreement requester is not the proper ledger management device 10 registered in the device list, the ledger management device 10 as the agreement responder responds in S15 not to agree the agreement request of the vehicle information registration with the ledger management device 10 as the agreement requester and the ledger management device 10 which is another agreement responder.

At S15, each ledger management device 10 adds and stores the ledger information currently generated by the ledger management device 10 as an agreement requester into the distributed ledger 24 when the predetermined number of the ledger management devices 10 agree the agreement request of the vehicle information registration as a preliminarily set agreement rule. As a result, the distributed ledger 24 provided in each of the plurality of ledger management devices 10 is synchronously updated, so that the distributed ledger 24 provided in each of the plurality of ledger management devices 10 has the same content.

In S15, each ledger management device 10 does not store the ledger information generated by the ledger management device 10 as the agreement requester in the distributed ledger 24 when only less than the predetermined number of ledger management devices 10 agree the agreement request of the vehicle information registration. In this case, the distributed ledger 24 is not updated.

[1-3. Effects]

In the first embodiment described above, the following effects can be obtained.

(1 a) The vehicle information provided from the vehicle 100 to the ledger management system 2 is recorded in the distributed ledger by the agreement of the plurality of ledger management devices 10 as ledger information including the hash value of the previous ledger information. As a result, since an agreement is not achieved even if an improper vehicle that pretends to be a registered vehicle for providing the vehicle information provides the vehicle information to the ledger management system 2, the improper vehicle information is restricted from being recorded in the distributed ledger.

In addition, even if an unauthorized third party tries to rewrite the ledger information in the distributed ledger, it is necessary to calculate the hash value set in all the ledger information following from the ledger information to be rewritten, so that the unauthorized third party needs to execute a large amount of process load for rewriting the ledger information in the distributed ledger. Therefore, it is virtually impossible for an unauthorized third party to rewrite the ledger information in the distributed ledger.

(1b) Since it is ensured that the ledger information recorded in the distributed ledger is proper, for example, a vehicle insurance company can set appropriate insurance fee using the ledger information such that the company raises an insurance fee of a vehicle tending to drive dangerously or lowers the insurance fee of a vehicle tending to drive safety.

Furthermore, since the driving characteristic of each vehicle can be acquired as the vehicle information from the ledger information, the company can calculate the insurance fee of each vehicle in more detail in addition to the accident history, the model year of the vehicle, and the like.

In addition, in a case where a company distributes software to vehicles, the company can charge a fee to the vehicle which uses the software when the company confirms from the ledger information recorded in the distributed ledger that the distributed software is used.

Also, in a case where a company is a used car sales company, it is possible to set an appropriate sales price of the used car since the company can determine how the vehicle has been used from the distributed ledger without unauthorized rewriting.

(1c) As a function of the vehicle, for example, the usage history of the function of the paid autonomous driving mode as the traveling mode is recorded as the ledger information in the distributed ledger. In addition, as a service that incurs payment of charges by using a vehicle, for example, in case of car sharing, a user who uses a car sharing system, car sharing start time and car sharing end time are recorded in the distributed ledger as ledger information.

Thus, the use of the service, which incurs the payment of charges by using a vehicle or using a paid function equipped in the vehicle, is recorded in the distributed ledger as the ledger information, so that the user cannot deny that the user have used the paid function or the paid service in order to avoid the payment of the charge.

Moreover, when the function of the vehicle or the service incurs the charge by the unit of time, the length of usage time cannot be applied for a short time.

In the first embodiment described above, the hash value 304 of the previous ledger information 300 generated by the information generation unit 16 corresponds to specific information specific to the ledger information.

Further, Steps S1, S11, and S12 correspond to the process in the information management unit, step S3 corresponds to the process in the registration determination unit, steps S3 and S14 correspond to the process in the information generation unit, and step S15 corresponds to the agreement determination unit and the ledger storage unit.

### 2. Second Embodiment

[2-1. Main Difference from the First Embodiment]

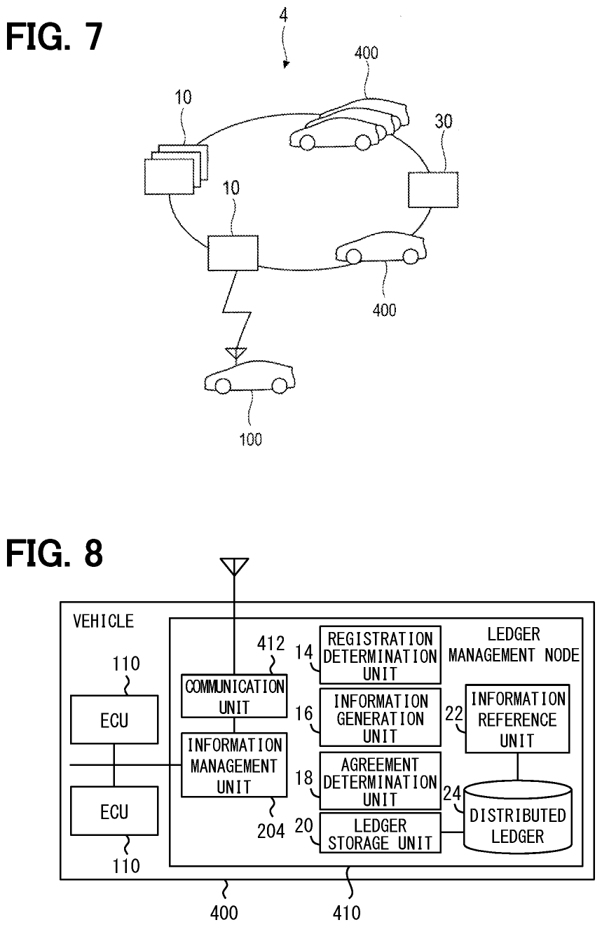

The second embodiment is different from the first embodiment in that a plurality of vehicles 400 are registered in the device list as a ledger management device of the ledger management system 4 as shown in FIG. 7. Note that the same reference numerals as those in the first embodiment indicate the same configuration, and refer to the previous descriptions.

As shown in FIG. 8, the vehicle 400 mounts a ledger management device 410 in which the configurations of the ledger management device 10 of the first embodiment and the information provision device 200 of the vehicle 100 are combined. The ledger management device 410 includes a registration determination unit 14, an information generation unit 16, an agreement determination unit 18, a ledger storage unit 20, an information reference unit 22, a distributed ledger 24, an information management unit 204, and a communication unit 412.

The communication unit 412 communicates with the ledger management device 10, the ledger management device 410 of another vehicle 400 registered as the ledger management device of the ledger management system 4, and the other vehicle 100 not registered as the ledger management device.

[2-2. Process]

The vehicle 400 executes a device registration request for registering as a ledger management device in the device list of the ledger management system 4, and an initial registration request described in the first embodiment for providing vehicle information to the ledger management system 4. Then, when the device registration and the initial registration are completed, the vehicle 400 executes an agreement request for providing vehicle information as an agreement requester.

By registering the vehicle 400 as the ledger management device of the ledger management system 4, safe and reliable information exchange can be performed between the vehicles 400 registered as the ledger management device.

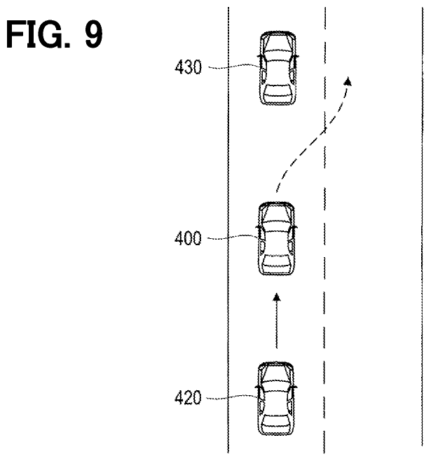

For example, as shown in FIG. 9, when the vehicles 400, 420, 430 travel in the same direction on a road with one traffic lane on one side, the vehicles 400, 420, 430 can travel while exchanging information and forming an agreement. A vehicle 420 traveling behind the vehicle 400 is defined to be a vehicle platooning with the vehicle 400.

In FIG. 9, the vehicle codes are different from 400, 420, 430 in order to distinguish the vehicles, but the vehicles 420, 430 are registered in the device list as a ledger management device of the ledger management system 4 similar to the vehicle 400, and have the ledger management devices 410 described above, respectively.

When the vehicle 400 tries to overtake the vehicle 430 traveling ahead, the vehicle 400 as an agreement requester transmits an agreement request for a request to overtake the leading vehicle 430 as vehicle information to the ledger management system 4. In this case, the vehicle 400 adds the overtaking request and the vehicle speed of the host vehicle as vehicle information to the time stamp and the hash value of the previous ledger information, and transmits them to the ledger management system 4 as ledger information.

After the vehicle 400 transmits to the ledger management system 4 an agreement request for a request to overtake the vehicle 430 ahead, the vehicle 430 ahead responds to the vehicles 400, 420 and the other ledger management device 10 that the vehicle 430 agrees with the agreement request of the vehicle 400 to overtake when the vehicle 400 that has transmitted the agreement request for overtaking is a proper vehicle registered in the device list, and the vehicle 430 ahead agrees to be overtaken by the vehicle 400.

Further, the following vehicle 420 platooning with the vehicle 400 responds to the vehicle 400, 430 and the other ledger management device 10 that the vehicle 420 agrees to follow the vehicle 400 and to overtake the vehicle 430 when the vehicle 400 that has transmitted the agreement request for overtaking is a proper vehicle registered in the device list, and the vehicle 420 behind together with the vehicle 400 agrees to overtake.

The other ledger management device 10 also responds to the vehicles 400, 420, 430 and other ledger management devices 10 that the device 10 agrees on the overtaking when the vehicle 400 that has transmitted the agreement request for overtaking is a proper vehicle registered in the device list, and the device 10 agrees that the vehicle 400 overtakes.

The vehicle 400 starts to overtake the vehicle 420 when the predetermined number or more of ledger management devices including at least the ledger management devices 410 of the vehicles 420 and 430 and combining other ledger management devices 10 agree with the overtaking request.

Here, when the communication between the vehicle 400 and the ledger management device 10 or other vehicles 400 is interrupted for a predetermined time or more since the vehicle 400 registered in the device list travels in the underground parking lot, in the tunnel, in the mountain area, etc., the corresponding vehicle 400 may be deleted from the device list. The vehicle 400 deleted from the device list again requests registration in the device list when the communication is restored.

Next, as an example of another consensus formation of the ledger management devices, a case where a taxi company and a taxi as the vehicle 400 are registered in the device list of the ledger management system 4 will be described.

For example, when receiving the ride-hailing request from a customer, the ledger management device 10 disposed in the taxi company becomes an agreement requester, and requests the allocation to the taxi in which the ledger management device 410 is arranged. For example, the taxi which is the agreement responder and requested for the allocation communicates with other taxis about the current position and the boarding status of each taxi, and the closest taxi to the pickup location which is currently an empty car responds to the ride-hailing request based on the agreement rules set in advance in the plurality of ledger management devices 410.

As a result, it is possible to omit the procedure for the taxi company to communicate with each taxi by a radio wave or the like, and to request the taxi which is currently vacant and closest to the dispatch location.

[2-3. Effects]

In the second embodiment described above, in addition to the effects (1 a) to (1c) of the first embodiment, the following effects can be obtained.

(2a) Since a plurality of vehicles are registered as a ledger management device of the ledger management system 4, reliable and appropriate traveling can be realized while each vehicle exchanges appropriate vehicle information with other vehicles.

### 3. Other Embodiments

(1) In the above embodiment, the information generation unit 16 generates the hash value 304 based on the previous ledger information 300 as specific information specific to the previous ledger information 300. Alternatively, the specific information specific to the previous ledger information is not limited to the hash value, and the unit 16 may generate any value as long as the value is specific to the immediately previous ledger information, and different values of ledger information result in different values.

(2) The distributed ledger 24 described in the above embodiments is not limited to the block chain. The distributed ledger may be a distributed ledger managed based on any agreement rule as long as the ledger information includes specific information specific to the immediately previous ledger information generated by one of the plurality of ledger management devices from the immediately previous ledger information and the current vehicle information provided from the vehicle, and the ledger information generated by one of the plurality of ledger management devices is stored in the distributed ledger when the ledger information satisfies the agreement rules set in the plurality of ledger management devices.

(3) A plurality of functions performed by one component in the above embodiments may be realized by a plurality of components, or one function performed by one component may be realized by a plurality of components. Further, a plurality of functions executed by a plurality of components may be realized by one component, or a single function realized by a plurality of components may be realized by a single component. Alternatively, a part of the configuration of the above embodiments may be omitted. Alternatively, at least a part of the configuration of the above embodiments may be added to or replaced with the configuration of the other above embodiment. It is to be noted that all aspects included in the technical concept specified by only the words described in claims are the embodiments of the present disclosure.

(4) The present disclosure may be realized in various forms such as a ledger management program for functioning a computer to function as the ledger management devices 10 and 410, a storage medium storing the ledger management program, a ledger management method, and the ledger management systems 2 and 4 having the ledger management devices 10 and 410 as components in addition to the ledger management devices 10 and 410 described above.

In addition to the information provision device 200 described above, the present disclosure may be realized in various forms such as an information provision program for functioning a computer as the information provision device 200, a storage medium storing the information provision program, and an information provision method.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A ledger management device for a ledger management system including a plurality of ledger management devices communicably connected to each other, wherein the plurality of ledger management devices have a same distributed ledger, the ledger management device comprising:
the distributed ledger storing a ledger information, including a specific information specific to a previous ledger information and a present vehicle information acquired from a vehicle, that is generated by one of the plurality of ledger management devices;
an agreement determination unit configured to determine whether the ledger information generated by the one of the plurality of ledger management devices satisfies an agreement rule set in the plurality of ledger management devices; and
a ledger storage unit configured to store the ledger information in the distributed ledger when the agreement determination unit determines that the ledger information satisfies the agreement rule, and not to store the ledger information in the distributed ledger when the agreement determination unit determines that the ledger information does not satisfy the agreement rule.

2. The ledger management device according to claim 1, further comprising:
an information generation unit configured to generate the ledger information including the present vehicle information acquired from the vehicle and the specific information specific to the previous ledger information generated from the previous ledger information.

3. The ledger management device according to claim 1, wherein:
the vehicle information includes at least one of a software configuration in the vehicle acquired from the vehicle, a usage record indicating how the vehicle has been used, and a traveling record indicating how the vehicle has traveled.

4. The ledger management device according to claim 1, further comprising:
an information reference unit configured to determine whether the ledger information to be referred to at a present time is proper, based on the ledger information to be referred to at the present time and the specific information of a next ledger information when referring to the ledger information stored in the distributed ledger.

5. The ledger management device according to claim 1, further comprising:
a registration determination unit configured to determine whether a registration request is proper when receiving an initial registration request for providing the vehicle information from the vehicle.

6. The ledger management device according to claim 1, wherein:
the ledger management device is mounted on the vehicle,
the ledger management device further comprising:
an information management unit configured to acquire a proper vehicle information from an electronic control unit mounted on the vehicle; and
a communication unit configured to transmit the proper vehicle information acquired by the information management unit to the ledger management system.

7. A ledger management system comprising:
a plurality of ledger management devices communicably connected to each other, wherein:
the plurality of ledger management devices has a same distributed ledger;
each of the plurality of ledger management devices includes:
the distributed ledger for storing a ledger information, including a specific information specific to a previous ledger information and a present vehicle information acquired from a vehicle, that is generated by one of the plurality of ledger management devices;
an agreement determination unit configured to determine whether the ledger information generated by the one of the plurality of ledger management devices satisfies an agreement rule set in the plurality of ledger management devices; and
a ledger storage unit configured to store the ledger information in the distributed ledger when the agreement determination unit determines that the ledger information satisfies the agreement rule, and not to store the ledger information in the distributed ledger when the agreement determination unit determines that the ledger information does not satisfy the agreement rule.

8. A vehicle-mounted information provision device for providing a vehicle information to a ledger management system including a plurality of ledger management devices communicably connected to each other,
wherein the plurality of ledger management devices has a same distributed ledger,
wherein the distributed ledger includes a specific information specific to a previous ledger information generated by one of the plurality of ledger management devices and a present vehicle information provided by the vehicle-mounted information provision device, and the distributed ledger stores the ledger information that satisfies an agreement rule set in the plurality of ledger management devices,
the vehicle-mounted information provision device comprising:
an information management unit configured to acquire a proper vehicle information from an in-vehicle electronic control device; and
a communication unit configured to transmit the proper vehicle information acquired by the information management unit to the ledger management system.

9. The vehicle-mounted information provision device according to claim 8, wherein:
the information management unit is configured to acquire at least one of a software configuration in the vehicle, a usage record indicating how the vehicle has been used, and a travel record indicating how the vehicle has traveled as the vehicle information.
